(19) United States
(12) Patent Application Publication
(10) Pub. No.: US 2025/0348053 A1
(43) Pub. Date: Nov. 13, 2025

(54) System and Method for Virtualization of Distributed Motion and Safety

(71) Applicant: Rockwell Automation Technologies, Inc., Mayfield Heights, OH (US)

(72) Inventors: Jesse R. Dunham, Willoughby Hills, OH (US); Bhanu K. Gouda, Reminderville, OH (US); Zubin Sethna, Mayfield Heights, OH (US)

(21) Appl. No.: 18/658,307

(22) Filed: May 8, 2024

(51) Int. Cl. G05B 19/05

(52) U.S. Cl. CPC G05B 19/058; G05B 19/054; G05B 2219/24033; G05B 2219/24061

(57) ABSTRACT

A distributed control system with multiple controllers generates a request data packet in a first controller. The request data packet is transmitted from the first controller to a second controller, and the request data packet is received at the second controller. The second controller simulates the presence of a signal on the second controller. The simulated signal is used by a series of instructions stored on the second controller, and the simulated signal is not present at an input for the second controller. The series of instructions are executed in response to receiving the request data packet, and a response data packet is generated on the second controller as a function of simulating the presence of the feedback signal and executing the series of instructions. The response data packet is transmitted from the second controller to the first controller.

### BACKGROUND INFORMATION

The subject matter disclosed herein relates to a system and method for virtual operation of devices in a distributed motion control application. More specifically, a first controller and a second controller are provided in a distributed control application, where each controller is configured to a control program and a model for at least a portion of the external devices connected to the corresponding controller.

As is known to those skilled in the art, a programmable controller is used to control operation of a machine or process. The programmable controller is often configurable to include different types and numbers of input and output modules. A control program executing on the programmable controller receives feedback signals at the inputs, where the feedback signals correspond to a present operating state of the controlled machine or process. The control program utilizes the feedback signals to set output signals for desired operation of an actuator in the controlled machine or process.

As controlled machines and processes grow more complex, multiple programmable controllers may be required for control. In some applications, a safety controller may be required to execute in parallel with a standard controller. The control programs executing on each controller typically require interaction between the controllers to coordinate operation of the controlled machine or process.

During the design process, it may be desirable to model how the multiple controllers interact. A simulation is a program executing on a computer which attempts to model how the controlled system operates. The simulation may be useful for determining, at least in part, how two controllers will interact. Simulations, however, have certain limitations. A simulation may only provide information based on the quality of the model provided to the simulation. It is often difficult or impossible to accurately model every aspect of a controlled system that affects how two controllers interact with each other. The simulation is dependent on the accuracy and completeness of the modelled data. Errors in the model or elements of the controlled system that are not included in the simulation decrease the effectiveness of the simulation. Thus, it would be desirable to provide an improved system and method for modelling the operation of distributed controllers for a controlled machine or process as the control system is being developed.

During commissioning of a controlled machine or process with multiple controllers, it is often necessary to enable portions of the controlled machine or process for verification while other portions of the controlled machine or process are either disabled or not yet installed. Without the full machine or process, it may only be possible to verify some operations while other operations cannot be verified. Thus, it would be desirable to provide an improved system and method for verification of a controlled system which models operation of portions of the controlled machine or process which are not present.

### BRIEF DESCRIPTION

According to one aspect of the invention, a safety control system for a motion application includes a safety device operative to generate a first feedback signal corresponding to a safety operation and a first controller. The first controller includes a first input to receive the first feedback signal, a first communication interface, a first memory operative to store a first set of instructions, and a first processor configured to execute the first set of instructions. The first processor executes the instructions to execute the safety operation responsive to the first feedback signal, execute the safety operation responsive to a virtual safety request data packet, and generate a virtual motion request data packet. The safety control system also includes a sensor operative to generate a second feedback signal corresponding to an operating state of the motion application and a second controller. The second controller includes a second input to receive the second feedback signal, a second communication interface operatively connected to the first communication interface to transmit data packets between the first communication interface and the second communication interface, a second memory operative to store a second set of instructions, and a second processor. The second processor is configured to execute the second set of instructions to execute a control routine as a function of the second feedback signal, execute the control routine responsive to the virtual motion request data packet, and generate the virtual safety request data packet.

According to another embodiment of the invention, a method for virtualization in a safety control system generates a request data packet in a first controller, transmits the request data packet from the first controller to a second controller, and receives the request data packet at the second controller. A signal is simulated on the second controller, where the signal is used by a series of instructions stored on the second controller. The signal is not present at an input for the second controller, and the series of instructions are executed in response to receiving the request data packet. A response data packet is generated on the second controller as a function of executing the series of instructions with the simulated signal, and the response data packet is transmitted from the second controller to the first controller.

According to still another embodiment of the invention, a distributed control system includes a first and a second controller. The first controller has a first input to receive a first input signal from a first device, a first memory operative to store a first set of instructions, and a first processor configured to execute the first set of instructions. The first processor selectively identifies when the first device is present, executes a first operation responsive to the first input signal to generate a first output signal when the first device is present, and executes a virtual operation to simulate the first input signal and to generate the first output signal when the first device is not present. A data packet is generated with the first output signal, and a first communication interface transmits the data packet with the first output signal. The second controller has a second communication interface operatively connected to the first communication interface to receive the data packet from the first communication interface, a second memory operative to store a second set of instructions, and a second processor configured to execute the second set of instructions to execute a second operation as a function of the first output signal present in the data packet.

These and other advantages and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Various exemplary embodiments of the subject matter disclosed herein are illustrated in the accompanying drawings in which like reference numerals represent like parts throughout, and in which:

FIG. 1 is a schematic representation of a partial control system incorporating one embodiment of the invention;

FIG. 2 is a block diagram representation of the controllers of FIG. 1;

FIG. 3 is a block diagram representation of execution by the controllers of FIG. 1;

FIG. 4 is a flow diagram illustrating steps for virtualization of distributed motion and safety according to embodiment of the invention;

FIG. 5 is a timing diagram illustrating one embodiment of time synchronization between two devices; and

FIG. 6 is a timing diagram illustrating network communication between two controllers.

In describing the various embodiments of the invention which are illustrated in the drawings, specific terminology will be resorted to for the sake of clarity. However, it is not intended that the invention be limited to the specific terms so selected and it is understood that each specific term includes all technical equivalents which operate in a similar manner to accomplish a similar purpose. For example, the word “connected,” “attached,” or terms similar thereto are often used. They are not limited to direct connection but include connection through other elements where such connection is recognized as being equivalent by those skilled in the art.

### DETAILED DESCRIPTION

The various features and advantageous details of the subject matter disclosed herein are explained more fully with reference to the non-limiting embodiments described in detail in the following description.

The subject matter disclosed herein describes an improved system and method for modelling the operation of distributed controllers for a controlled machine or process as the control system is being developed. Similarly, the system and method for modelling the operation of distributed controllers may be used for verification of operation of portions of the controlled machine or process which are not present. Each controller includes a control program configured to execute on the respective controller. During development or during deployment of a control system, hardware may not be present to evaluate real-time performance of the control system. For a safety controller, it may be desirable to determine how a standard controller will respond to the safety controller detecting an event which requires the control system to enter a predefined, safe operating state. However, it may not be possible to evaluate the response of the standard controller when the controlled elements are not connected to the standard controller. Similarly, it may also be desirable for a standard controller to verify that controlled elements enter a desired operating state when a safety event occurs. However, verification of this operation may not be possible if the safety hardware is not connected to the safety controller. Previously, simulation on a separate computer was needed to emulate operation of an element controlled by either the standard controller or the safety controller when the controlled elements are not yet connected to the respective controller. However, emulation on a separate computer cannot accurately capture the real-time interaction between devices in the control system including, but not limited to, receiving inputs from devices, processing control programs, and communicating via an industrial network.

The present invention provides virtual devices for execution within each controller when the physical devices are not present. In addition to the control programs in each controller, one or more operating models are stored within the controller. The safety controller, for example, includes a safety control program as well as one or more safety models corresponding to one or more safety devices which are to be connected to the safety controller. The safety controller is configured to execute the safety control program as if all devices are connected to the safety controller. The operating model, or models, are selectively enabled to generate control signals corresponding to their respective device. The control signals are utilized by the safety controller as if the device is connected to the safety controller. Similarly, the standard controller includes one or more operating models stored along with the control programs within the standard controller. The standard controller, for example, includes a standard control program which controls operation of one or more actuators connected to the standard controller. The standard controller is configured to execute the standard control program as if all devices are connected to the standard controller. The operating model, or models, are selectively enabled to generate control signals corresponding to their respective devices. The control signals are utilized by the standard controller as if the device is connected to the standard controller. The operating models permit each controller to virtualize the presence of a device which is either not connected or temporarily disabled from operation in order to evaluate performance of the virtualized device.

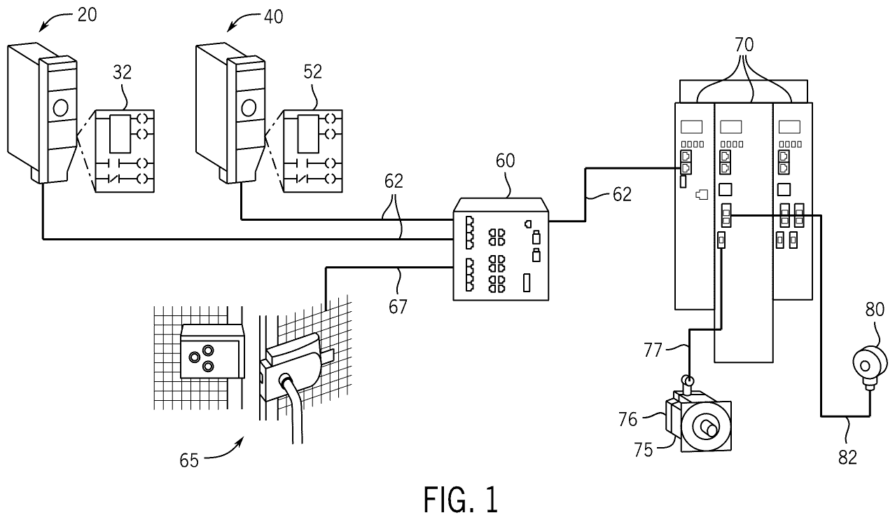

Turning initially to FIG. 1, an exemplary control system includes two controllers. For purpose of illustration, the two controllers may be a standard controller 40 and a safety controller 20. The standard controller 40 is configured to operate a controlled machine or process. A standard control program 52, executing on the standard controller 40, receives feedback signals from devices in the controlled machine or process and generates outputs to achieve a desired operation. A safety control program 32, executing on the safety controller 20, may monitor a portion of the controlled machine or process or it may monitor dedicated safety devices.

Safety control is used in applications where failure of an industrial controller, or of a device in the industrial control system, can create a risk of injury to humans. While safety control is closely related to reliability, safety control places additional emphasis on ensuring correct operation even if it reduces equipment availability. Safety industrial control systems are not optimized for “availability”, that is, being able to function for long periods of time without error, but rather for “safety” which is being able to accurately detect error to shut down. Safety industrial controllers normally provide a predetermined safe state for their outputs upon a safety shutdown. The predetermined values of these outputs are intended to put the industrial process into its safest static mode. For that reason, safety controllers may provide run time diagnostic capabilities to detect incorrect operation and to move the control system to predefined “safety states” if a failure is detected. The safety states will depend on the particular process being implemented and cause the actuators to assume a state predetermined to be safest when control correctness cannot be ensured. For example, an actuator controlling cutting machinery might move that machinery to a stop state while an actuator providing air filtration might retain that machinery in an on state.

Safety control capability may be designated, for example, by “safety integrity levels” (SIL) defined under standard IEC 61508 and administered by the International Electrotechnical Commission (IEC) under rule hereby incorporated by reference. Standard IEC EN 61508 defines four SIL levels of SIL-1 to SIL-4 with higher numbers representing higher amounts of risk reduction. Obtaining a desired SIL rating requires a certain degree of diagnostic coverage for components within a system. The degree of diagnostic coverage is defined according to a percentage likelihood that a failure of a component within a system will be detected. Low diagnostic coverage, for example, may require only a sixty percent (60%) chance that a failure will be detected. In contrast, high diagnostic coverage, required for a SIL 3 rating, may require a ninety-nine percent (99%) chance that a failure will be detected. Mitigation of a risk occurring increases the SIL rating and may be achieved by detecting a failure in a system that may cause a dangerous failure before the failure can occur. Therefore, determination of a SIL rating is based, at least in part, on the ability of a system to detect a fault condition and to enter a safe state in response to detecting the fault condition. In order to permit interaction of a person with the controlled machine or process, it is necessary to obtain a safety rating, where the safety level required may be a function of the degree of interaction required.

The exemplary control system includes an industrial network, where a network device 60, such as a gateway, bridge, or switch, is connected by network media 62 between the standard controller 40, the safety controller 20, and other devices in the controlled machine or process. The network media 62 may include wired network cables, wireless communication interfaces, or a combination thereof. For illustration, a lock 65 on a gate for an enclosed space around the controlled machine or process generates at least one feedback signal 67 corresponding to the present state of the lock 65. The feedback signal 67 may indicate, for example, whether the lock 65 is in a locked state or an unlocked state. An additional feedback signal 67 may also indicate if the gate is in an open state or a closed state utilizing a proximity sensor within the lock 65. Also illustrated is a set of motor drives 70. One of the motor drives 70 is connected to a motor 75 and encoder 76 via a first cable 77. The first cable 77 includes power conductors to supply a controlled voltage from the motor drive 70 to the motor 75 for desired operation of the motor. The first cable 77 also includes communication conductors to receive position feedback from an encoder 76 mounted on the motor, where the position feedback corresponds to an angular position of the motor. Also illustrated is a secondary encoder 80 and a second cable 82 extending between the secondary encoder 80 and the motor drive 70. The secondary encoder 80 may be mounted to the motor 75 or at another location along the drive train of an axis controlled by the motor drive 70. The secondary encoder 80 may provide a redundant position feedback signal for the motor 75, if connected to the motor, or the secondary encoder 80 may provide a safety check on the drive train of the controlled axis to verify, for example, rotation of a driven member after coupling via a gear train, belts, pulleys, chains, or other such drive train members. The illustrated devices are exemplary and not limiting. It is understood that various numbers and configurations of electrical devices may be connected within the controlled machine or process. The electrical devices may provide feedback signals to the standard controller 40, the safety controller 20, or to both controllers. The electrical devices may also be actuated by the standard controller 40, the safety controller 20, or a combination thereof.

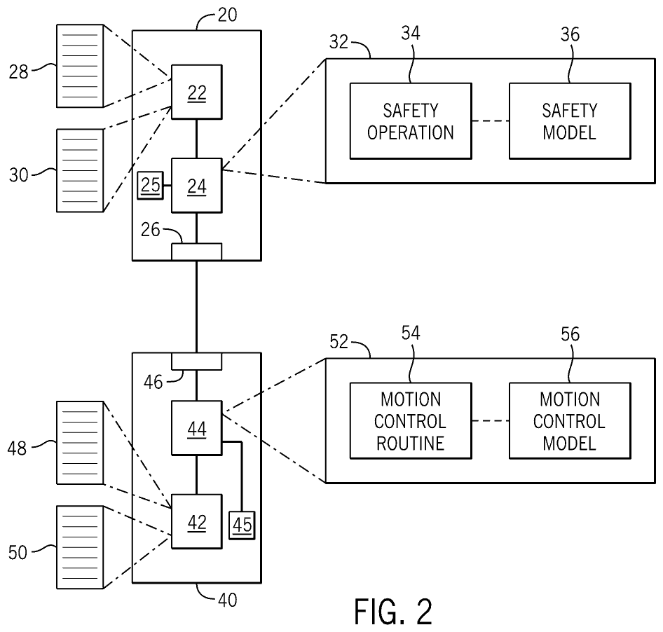

Turning next to FIG. 2, the safety controller 20 includes a memory 22 and a processor 24. The memory 22 may be a single device or multiple devices. The memory 22 includes transitory and non-transitory memory. The processor 24 may be a single processor or multiple processors executing synchronously or asynchronously. The processor 24 may be a microprocessor or a custom programmable processing device such as a field programmable gate array (FPGA), programmable array logic (PAL), programmable system on a chip (PSoC), complex programmable logic device (CPLD), application specific integrated circuit (ASIC), or the like. Optionally, the memory 22 and the processor 24 may be incorporated onto a microcontroller, one of the programmable processing devices, or other suitable device. The memory 22 is operative to store data, configuration parameters 28, instructions 30 for the control programs 32, and the like. The processor 24 is in communication with the memory 22 to read or write data from the memory 22 and to execute instructions 30 stored in the memory 22. The safety controller 20 also includes a clock circuit 25, which generates one or more clock signals utilized by the processor 24 and other electronic devices within the safety controller 20 for execution. A communication interface 26 connects the safety controller 20 to the industrial network for communication with other devices on the industrial network.

The standard controller 40 includes a memory 42 and a processor 44. The memory 42 may be a single device or multiple devices. The memory 42 includes transitory and non-transitory memory. The processor 44 may be a single processor or multiple processors executing synchronously or asynchronously. The processor 44 may be a microprocessor or a custom programmable processing device such as a field programmable gate array (FPGA), programmable array logic (PAL), programmable system on a chip (PSoC), complex programmable logic device (CPLD), application specific integrated circuit (ASIC), or the like. Optionally, the memory 42 and the processor 44 may be incorporated onto a microcontroller, one of the programmable processing devices, or other suitable device. The memory 42 is operative to store data, configuration parameters 48, instructions 50 for the control programs 52, and the like. The processor 44 is in communication with the memory 42 to read or write data from the memory 42 and to execute instructions 50 stored in the memory 42. The standard controller 40 also includes a clock circuit 45, which generates one or more clock signals utilized by the processor 44 and other electronic devices within the standard controller 40 for execution. A communication interface 46 connects the standard controller 40 to the industrial network for communication with other devices on the industrial network.

According to one aspect of the invention, each controller 20, 40 includes one or more input modules, output modules, combined input and output modules, or a combination thereof connected to the controller. Input and output signals may be digital, analog, or a combination thereof. Different modules are configured to receive or deliver different types of input and output signal. The number and type of connected modules vary according to application requirements. According to still another aspect of the invention, input and output signals may be communicated in data packets via the industrial network. The illustrated lock 65, for example, communicates via the switch 60 with the safety controller 20, and the motor drives 70 communicate via the switch 60 to the motion controller 40.

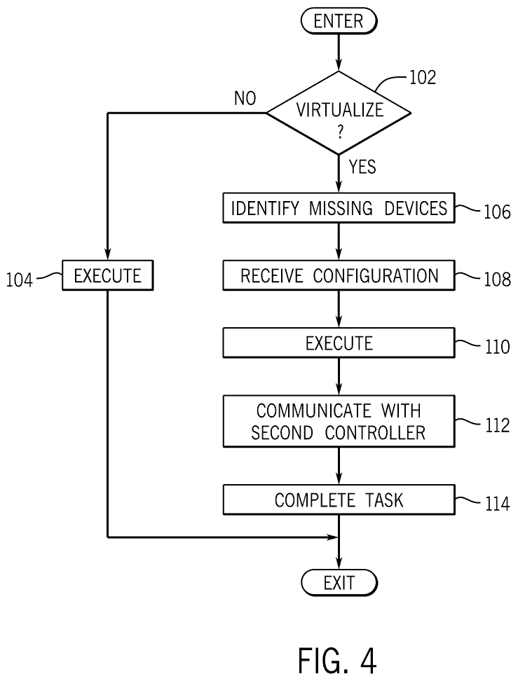

In operation, each distributed controller 20, 40 includes a control program 32, 52, executable on the respective controller, and a virtualization model to generate control signals corresponding to at least one device that is to be connected to the controller during normal operation of the controlled machine or process. When all devices are connected to the respective controllers 20, 40 and the controllers are fully operational, each controller receives input signals from devices connected to the controller, executes the respective control programs, and generates output signals for other devices connected to the controller as a function of the input signals and of the control program executing on the controller. With reference to FIG. 4, normal operation of each controller is shown by steps 102 and 104. The control program begins execution and determines at step 102 whether any devices require virtualization. If all devices are connected and operational, the control program executes normally 104. If, however, one or more devices are missing and one of the controllers 20, 40 is required to execute the model 36, 56 for the device, execution continues at step 106.

As shown in step 106, it is necessary to identify which devices are missing. According to one aspect of the invention, a Human Machine Interface (HMI) may be provided for the controlled system. A single HMI may be provided for the entire system, separate HMIs may be provided for each controller 20, 40, or multiple HMIs may be distributed around the controlled system according to the application requirements. The HMI includes at least one screen to provide a visual indication of the status of the controlled system. A segment or device which is missing or which has not yet been verified during a commissioning process may be highlighted with an error message, a flashing symbol, or the like. A user interface, such as a touchscreen, keypad, touchpad, trackball, or the like allows a technician to select a device and determine the present status for the device. Further, if the technician wishes to run or verify a different portion of the controlled system, where the other portion of the controlled system interacts with the missing device, the user interface allows the technician to select the device presently missing to be modelled by the controller 20, 40 to which it is intended to be connected.

According to another aspect of the invention, a remote computing device may connect to the controller 20, 40 via a wired or wireless connection. The remote computing device may be, for example, a tablet device in proximity with the controller and configured to communicate via a cable, near-field communications such as Bluetooth, or Wi-Fi. Optionally, the computing device may be a notebook, laptop, or desktop computing device connected to the controller 20, 40 via a local area network (LAN), a wide area network (WAN), or a combination thereof. A technician may utilize the remote computing device to selectively enable or disable devices to be modelled by the corresponding controller 20, 40.

During operation, the two controllers 20, 40 each execute their respective control programs 32, 52. As previously discussed, the first controller 20 is configured as a safety controller and executes a safety operation 34. The safety operation 34 monitors one or more safety devices, such as the lock 65 illustrated in FIG. 1, and puts the control system into a safe operating state, or one of several safe operating states, as a function of the feedback signals received from the safety devices. The second controller 40 is configured as a motion controller and executes a motion control routine 54. The motion control routine 54 is responsible for controlling operation of at least one axis of motion in the controlled machine or process. The axis of motion includes at least one motor drive 70 which receives a motion profile from the motion control routine 54. The motor drive 70, in turn, controls at least one motor 75 corresponding to the motion profile received from the motion control routine. This application is not intended to be limiting. It is contemplated that the virtualization routine may be executed on two safety controllers, two motion controllers, on other controllers executing other control programs, or combinations thereof. For purposes of discussion herein, the first controller 20 will be discussed as a safety controller, and the second controller 40 will be discussed as a motion controller.

During operation, each controller 20, 40 relies, at least in part, upon execution of the other controller. Data is communicated via the corresponding communication interfaces 26, 46 and the industrial network. The control program 32, 52 executing in each controller 20, 40 performs at least one function in response to receiving data from the other controller. According to an exemplary application, the lock 65 is on a gate enclosing an area in which the motor 75 is located. The motion controller 40 is responsible for controlling operation of the motor 75, and the safety controller 20 is responsible for monitoring the lock 65. The safety controller 20 transmits data to the motion controller 40 corresponding to the present operating state of the lock 65, and the motion controller 40 transmits data to the safety controller 20 corresponding to the present operating state of the motor 75. When the gate is closed and the lock 65 is in a locked state, the motion controller 40 is able to control operation of the motor 75 normally according to the motion control routine 54. If, however, a technician wishes to enter the enclosed space and unlocks the lock 65, the safety controller 20 must execute the safety operation 34 to enter a safe operating state. A safe operating state is dependent on the application requirements. For example, a safe operating state may permit some motion of the controlled axis, where the motion may be limited to a reduced range of motion or a reduced speed or operation for the motor 75. Alternately, the safe operating state may require the motor 75 be brought to a stop prior to allowing entry into the enclosed space. Further, multiple safe operating states may be defined where a first safe operating state corresponds to the lock 65 being unlocked and a second safe operating state corresponds to the gate on which the lock 65 is mounted opening.

Because each controller 20, 40 is independently executing their respective control program 32, 52, events occur and outputs are generated by each controller asynchronously of each other. In some applications, however, it is desirable to coordinate execution of each controller. It may be necessary for one controller 20, 40 to know when an event occurred on the other controller. In order to achieve coordinated execution between distributed controllers, the clock circuits 25, 45 in each controller may be synchronized to a single, master clock.

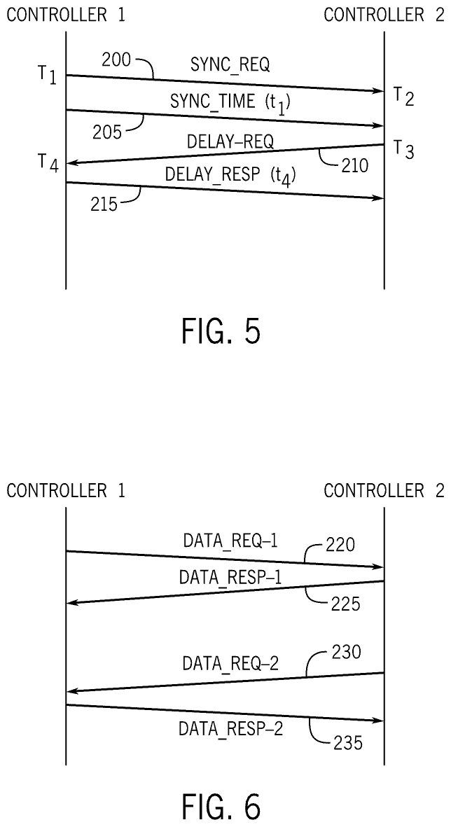

With reference to FIG. 5, an example of time synchronization between two controllers in the industrial control system is illustrated. Controller 1 is illustrated as transmitting a synchronize request message 200 to Controller 2 along the industrial network. For discussion herein, Controller 1 will be referenced with respect to the safety controller 20 and Controller 2 will be referenced with respect to the standard controller 40. The synchronize request message 200 is transmitted at time, T₁. Controller 1 captures a timestamp of time, T₁, using its clock circuit 25. According to one aspect of the invention, the processor 24 in Controller 1 may capture the timestamp at the time it sends the synchronize request message 200 to its corresponding communication interface 26 for transmission. According to another aspect of the invention, it is contemplated that the communication interface 26 or a dedicated circuit located between the processor 24 and the communication interface 26 may be configured to capture a timestamp utilizing a hardware circuit. Implementing a hardware circuit to capture a timestamp may allow for a more precise timestamp corresponding to the time the synchronize request message 200 leaves Controller 1. Because the timestamp is captured as close as possible to the time the message leaves Controller 1, the timestamp may not be included within the synchronize request message 200. Controller 1 transmits a second message, Sync_time, with the timestamp, t₁, included in the data packet. Optionally, the hardware circuit may be configured to append the timestamp, T₁, to the initial synchronize request message 200 and include the timestamp in the synchronize request message 200 if the timestamp may be appended quickly enough to not delay the transmission of the request message 200 beyond the application requirements.

Controller 2 receives the synchronize request message 200 at time, T₂, and obtains a second timestamp corresponding to the time the synchronize request message is received. As may be appreciated, the first timestamp, T₁, is captured as a function of the local time in Controller 1. The local time in Controller 1 may serve as a master time for the control system or, alternately, the local time in Controller 1 may have been previously synchronized to a master time. The second timestamp, T₂, is captured as a function of the local time in Controller 2, which has not yet been synchronized to the master time. As a result, there will be an offset between the local times in the two controllers. According to one aspect of the invention, the processor 44 in Controller 2 may capture the timestamp at the time it receives the synchronize request message 200 from its corresponding communication interface 46. According to another aspect of the invention, it is contemplated that the communication interface 46 or a dedicated circuit located between the processor 44 and the communication interface 46 may be configured to capture a timestamp utilizing a hardware circuit. Implementing a hardware circuit to capture a timestamp may allow for a more precise timestamp corresponding to the time the synchronize request message 200 arrives at Controller 2. Controller 2 also receives the second message 205, Sync_time, with the timestamp, T₁, included in the data packet. Controller 2 stores the first and second timestamps in memory 42.

Controller 2 then determines a transmission delay time for a message sent from Controller 2 to Controller 1. A delay request message 210 is generated within Controller 2 and sent from the communication interface 46 of Controller 2 to the communication interface 26 of Controller 1. Controller 2 captures a third timestamp, T₃, using the local time in Controller 2, where the third timestamp corresponds to the time that the delay request message was transmitted. As previously discussed, either the processor 44 in Controller 2 or a hardware circuit in the communication interface 46 or a dedicated circuit located between the processor 44 and the communication interface 46 may be configured to capture the timestamp. The third timestamp, T₃, is stored with the first and second timestamps. The delay request message 210 is received at Controller 1 at time, T₄. The processor 24 in Controller 1, a hardware circuit in the communication interface 26, or a dedicated circuit located between the processor 24 and the communication interface 26 may be configured to capture the timestamp of the time the delay request message 210 as it is received. Controller 1 then sends a delay response message 215 back to Controller 2, where the delay response message included the fourth timestamp, T₄. Controller 2 receives the fourth timestamp and stores it with the first three timestamps.

Controller 2 may then use the four timestamps to determine a time offset for the local time in Controller 2 from the master time. The third timestamp, T₃, is captured as a function of the local time in Controller 2, which has not yet been synchronized to the master time, and the fourth timestamp, T₄, is captured as a function of the local time in Controller 1, which either serves as or has been synchronized to the master time. As a result, there will be an offset between the local times in the two devices. The offset may be determined as shown below in equation 1.

$$offset = ( ( {t}_{2} - {t}_{1} ) - ( {t}_{4} - {t}_{3} ) ) / 2 \qquad ( 1 )$$

In equation 1, the transmission delay is determined from Controller 1 to Controller 2 for the synchronize request message 200 and from Controller 2 to Controller 1 for the delay request message 210. Subtracting the two values of the transmission delay where the transmission delays are determined using clock values from different local clocks has the effect of cancelling out the transmission delay and leaving a remainder of twice the offset between the two clocks. As a result, dividing the difference of the transmission delay values by two provides the offset value between the local clock values of the two devices. Controller 2 will now have an offset value for its local time with respect to the master clock value and can synchronize itself to the master clock. Adding the offset value to the local time will result in a clock signal that is synchronous to the value of the master clock. The controllers may also be periodically resynchronized to ensure that the local time in each device remains synchronized. It is contemplated that resynchronization may occur, for example, at intervals ranging from one-half second to five seconds.

With reference next to step 108 in FIG. 4, it is contemplated that the configuration of the control system may be distributed between controllers. With reference again to the safety controller 20 and motion controller 40 example discussed above, the safety controller 20 may, for example, include one or parameters defining a desired safe state for the motor 75 when the lock 65 is unlocked and/or a desired safe state for the motor 75 when the gate is open. The motion controller 40 includes configuration parameters defining desired operation of the motor 75, such as maximum velocity or maximum acceleration. The safety controller 20 may need information on the configuration of the motor 75 to determine a desired safe operating state. Similarly, the motion controller 40 may need information on the desired safe operating state defined in the safety controller 20. In order to accurately model how a missing device is to function, the configuration data, or a portion thereof, from one controller may be communicated to the other controller for use in the virtualization process.

At steps 110 and 112 in FIG. 4, each controller 20, 40 begins execution of their respective control program 32, 52 to verify desired operation. At least a portion of the execution requires communication between controllers 20, 40. Although illustrated as two sequential steps in the flow diagram, it is contemplated that the execution of the control programs and communication between controllers may occur in either order and/or may require multiple iterations of execution and/or communication between controllers to complete the desired operation. Within steps 110 and 112, each controller 20, 40 is configured to execute virtualization steps as needed to model execution of devices which were previously defined as missing or non-functioning in step 106.

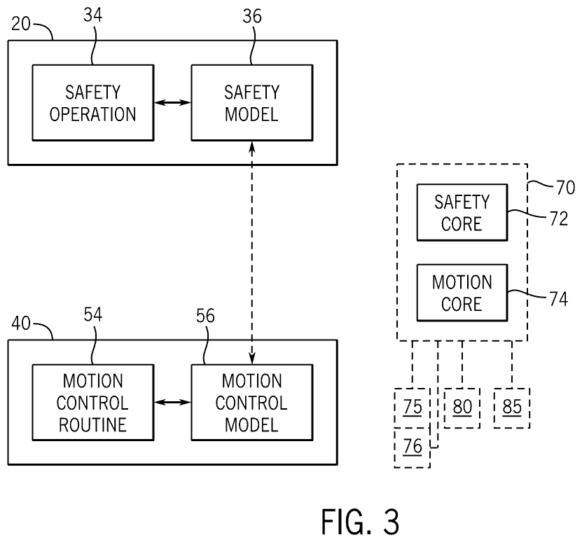

Turning next to FIG. 3, it is contemplated that the motor drive 70 is either not present or is not yet ready to run as indicated. The motor drive 70 was identified as absent via the HMI or remote computing device, as discussed above, or according to any other suitable method of indicating that the motor drive 70 is not available for execution. According to the illustrated embodiment, the motor drive 70 includes both a safety core 72 and a motion core 74. The safety controller 20 includes in its safety model 36 functions to be performed by the safety core 72 in the motor drive. The motion controller 40 includes in its motion control model 56 functions to be performed by the motion core 74 in the motor drive. The illustrated embodiment further shows a motor 75, a motor mounted encoder 76, a safety encoder 80, and at least one additional sensor 85 to be connected to the motor drive 70. While these devices may or may not be present on the controlled machine or process, because the motor drive 70 is not present or is not yet ready to be run, the signals generated by these devices are not available to either controller 20, 40.

The safety model 36 and the motion control model 56 will each need to generate signals for their respective safety operation 34 and motion control routine 54 as required by each controller 20, 40 in order to verify operation of the control programs. It is further contemplated that only one of the controllers 20, 40 may be configured to model operation of at least a portion of a missing device, such as the motor drive 70. For example, the motion control model 56 may be configured to receive run commands from the motion control routine 54 that correspond to desired operation of the motor 75. The second controller 40 includes configuration data corresponding to the motor drive 70, the motor 75, the motor mounted encoder 76, and the safety encoder 80. The motion control model 56 utilizes the configuration data and the run command to generate a position feedback signal, a velocity feedback signal, or other potential feedback signals required by the motion controller 40. If, for example, an expected load present at the motor has been entered into configuration data or via the HMI or remote computing device, the motion control model 56 may generate a current feedback signal corresponding to an expected current generated by the motor drive 70 if it were controlling the motor 75. Further, the motion control model 56 may adapt the acceleration and/or deceleration rates of the motor 75 as a function of the expected load present on the motor 75. Generation of these feedback signals via the motion control model 56 allow the control program 52 executing in the motion controller 40 to operate as if the motor drive 70 were present even when the motor drive is not available.

Providing virtual operation of the motor drive 70 within the motion controller 40 permits verification of operation by one controller when a device is not present on a second controller. For example, a safety operation from the safety controller 20 may be verified even when the motor drive is not available. According to the exemplary application, the lock 65 on the gate is unlocked and/or the gate opened and a safety operation is required. Under the application requirements, it may be necessary to bring the machine to a complete stop within a predefined time, such as one second, to achieve a safe operating state for a technician to enter the enclosed space. The control programs 32, 53 on each controller 20, 40 may be executed without the motor drive 70 connected. A technician may change the state of the lock 65 and the safety controller 20 detects the need for the predefined safe operating state. As shown in FIG. 6, the first controller 20 is configured to transmit data request messages 220 to the second controller 40, and the second controller transmits response messages 225 back to the first controller. An exemplary data request message 220 may be a motion request message from the safety controller 20 to the motion controller 40 indicating that the motor 75 is to be brought to a stop. The second controller acknowledges the request message in the data response 225 and takes the required action. The control program 52 executing on the motion controller 40 receives the motion request and generates a new motion command for the motor 75. Because the motor and motor drive are not available, the motion control model 56 generates a virtual feedback signal corresponding to the motor 75 slowing. The motion control routine 54 recognizes when the virtual motor 75 has come to a stop and transmits a message back to the safety controller 20. The safety controller 20 may then confirm whether the motor 75 was brought to a stop within the one second according to the application requirements.

As also shown in FIG. 6, the second controller 40 is similarly configured to transmit data messages 230 to the first controller 20, and the first controller transmits response messages 235 back to the second controller. An exemplary data message 230 is a message from the motion controller 40 to the safety controller 20 indicating that the virtual motor 75 has stopped. The message transmitted from the second controller would similarly have been generated by the motion control routine 54 if the motor 75 were present and being actively controlled by the motor drive 70 when the motor 75 came to a stop. The first controller 20 is able to execute its control program 32 without modification whether the second controller 40 is connected to a motor drive 70 or if the second controller is executing a virtual model of the motor drive 70.

As noted in FIG. 4 and as discussed above, the controllers 20, 40 execute their respective control programs 32, 52 and communicate with each other via the industrial network. Traffic over the industrial network is one aspect of an industrial control system that is very difficult to simulate. The ability for each controller 20, 40 to communicate data packets with each other, monitor communication for responses, and execute their respective control programs in real-time on the industrial network is an advantage provided by the models 36, 56 executing on each controller. This communication may be impacted by the volume of traffic causing varying latency in communication between controllers. Execution of the control programs with at least a portion of the hardware-in-the-loop provides an improved system and method for modelling the interaction of distributed controllers for a controlled machine or process as the control system is being developed or for verification of the controlled machine or process during commissioning when portions of the controlled machine or process are not present.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

In the preceding specification, various embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

We claim:

1. A safety control system for a motion application, comprising:
a safety device operative to generate a first feedback signal corresponding to a safety operation;
a first controller, including:
a first input to receive the first feedback signal;
a first communication interface;
a first memory operative to store a first plurality of instructions; and
a first processor configured to execute the first plurality of instructions to:
execute the safety operation responsive to the first feedback signal,
execute the safety operation responsive to a virtual safety request data packet, and
generate a virtual motion request data packet;
a sensor operative to generate a second feedback signal corresponding to an operating state of the motion application;
a second controller, including:
a second input to receive the second feedback signal;
a second communication interface operatively connected to the first communication interface to transmit data packets between the first communication interface and the second communication interface;
a second memory operative to store a second plurality of instructions; and
a second processor configured to execute the second plurality of instructions to:
execute a control routine as a function of the second feedback signal,
execute the control routine responsive to the virtual motion request data packet, and
generate the virtual safety request data packet.

2. The safety control system of claim 1, wherein the first processor is further operative to execute a safety model responsive to the virtual safety request data packet to generate at least one virtual safety signal, wherein the step of executing the safety operation responsive to the virtual safety request data packet further executes as a function of the at least one virtual safety signal generated by the safety model.

3. The safety control system of claim 2, wherein the first processor is further configured to:
generate a virtual safety response data packet after executing the safety operation responsive to the virtual safety request data packet, and
transmit the virtual safety response data packet to the second controller.

4. The safety control system of claim 1, wherein the second processor is further operative to execute a control model responsive to the virtual motion request data packet to generate at least one virtual control signal, wherein the step of executing the control routine responsive to the virtual motion request data packet further executes as a function of the at least one virtual control signal generated by the control model.

5. The safety control system of claim 4, wherein the second processor is further configured to:
generate a virtual motion response data packet after executing the control routine responsive to the virtual motion request data packet, and
transmit the virtual motion response data packet to the first controller.

6. The safety control system of claim 1, wherein:
the first controller includes a first clock circuit, and
the second controller includes a second clock circuit synchronized to the first clock circuit.

7. The safety control system of claim 1, wherein:
the first memory is further operative to store at least one configuration parameter,
the first processor is further operative to include the at least one configuration parameter in the virtual motion request data packet, and
the second processor is further operative to execute the control routine as a function of the at least one configuration parameter.

8. The safety control system of claim 1, wherein:
the second memory is further operative to store at least one configuration parameter,
the second processor is further operative to include the at least one configuration parameter in the virtual safety request data packet, and
the first processor is further operative to execute the safety operation as a function of the at least one configuration parameter.

9. A method for virtualization in a safety control system, the method comprising the steps of:
generating a request data packet in a first controller;
transmitting the request data packet from the first controller to a second controller;
receiving the request data packet at the second controller;
simulating a signal on the second controller, wherein:
the signal is used by a series of instructions stored on the second controller,
the signal is not present at an input for the second controller, and
the series of instructions are executed in response to receiving the request data packet;
generating a response data packet on the second controller as a function of executing the series of instructions with the simulated signal; and
transmitting the response data packet from the second controller to the first controller.

10. The method of claim 9, wherein:
the first controller is a motion controller;
the second controller is a safety controller; and
simulating the signal further includes executing a safety operation with the safety controller responsive to receiving the request data packet, wherein the safety controller is operative to execute the safety operation when the signal is present at an input of the safety controller.

11. The method of claim 9, wherein:
the first controller is a safety controller;
the second controller is a motion controller; and
simulating the signal further includes executing a control routine with the motion controller responsive to receiving the request data packet, wherein the motion controller is operative to execute the control routine when the signal is present at an input of the motion controller.

12. The method of claim 9, further comprising an initial step of synchronizing a first clock circuit in the first controller with a second clock circuit in the second controller.

13. The method of claim 7, wherein:
the first controller includes a memory operative to store at least one configuration parameter;
the first controller includes the at least one configuration parameter in the request data packet; and
the second controller simulates the signal as a function of the at least one configuration parameter.

14. A distributed control system, comprising:
a first controller, including:
a first input to receive a first input signal from a first device;
a first memory operative to store a first plurality of instructions;
a first processor configured to execute the first plurality of instructions to:
selectively identify when the first device is present,
execute a first operation responsive to the first input signal to generate a first output signal when the first device is present,
execute a virtual operation to simulate the first input signal and to generate the first output signal when the first device is not present, and
generate a data packet with the first output signal; and
a first communication interface to transmit the data packet with the first output signal; and
a second controller, including:
a second communication interface operatively connected to the first communication interface to receive the data packet from the first communication interface;
a second memory operative to store a second plurality of instructions; and
a second processor configured to execute the second plurality of instructions to execute a second operation as a function of the first output signal present in the data packet.

15. The distributed control system of claim 14, wherein:
the first operation is a safety operation,
the first processor is further configured to execute the safety operation responsive to the first input signal received either from the first input or from the virtual operation.

16. The distributed control system of claim 15, wherein the first processor is further configured to:
generate a virtual safety data packet after executing the safety operation responsive to the simulated first input signal, and
transmit the virtual safety data packet to the second controller.

17. The distributed control system of claim 14, wherein:
the second controller further includes a second input to receive a second input signal from a second device;
the second processor is further configured to:
execute the second plurality of instructions to:
selectively identify when the second device is present,
execute the second operation responsive to the second input signal to generate a second output signal when the second device is present,
execute a virtual operation to simulate the second input signal and to generate the second output signal when the second device is not present, and
generate a data packet with the second output signal; and
the second communication interface is operative to transmit the data packet with the second output signal to the first communication interface.

18. The distributed control system of claim 17, wherein the first processor is further configured to execute the first operation as a function of the second output signal received via the data packet from the second controller.

19. The distributed control system of claim 14, wherein:
the first controller includes a first clock circuit, and
the second controller includes a second clock circuit synchronized to the first clock circuit.

20. The distributed control system of claim 14, wherein:
the first memory is further operative to store at least one first configuration parameter,
the first processor is further operative to include the at least one first configuration parameter in the data packet, and
the second processor is further operative to execute the second operation as a function of the at least one first configuration parameter.
